(19) United States
(12) Patent Application Publication
(10) Pub. No.: US 2026/0256201 A1
(43) Pub. Date: Sep. 3, 2026

(54) HEATER ASSEMBLY AND AEROSOL GENERATION DEVICE COMPRISING SAME

(71) Applicant: KT&G CORPORATION, Daejeon (KR)

(72) Inventors: In Su PARK, Daejeon (KR); Chan Min KWON, Daejeon (KR); Sung Jong KI, Daejeon (KR); Tae Kyun KIM, Daejeon (KR); Ick Joong KIM, Daejeon (KR); Mi Jeong LEE, Daejeon (KR); John Tae LEE, Daejeon (KR); Tae Kyung LEE, Daejeon (KR)

(73) Assignee: KT&G CORPORATION, Daejeon (KR)

(21) Appl. No.: 18/881,768

(22) PCT Filed: Aug. 31, 2023
(86) PCT No.: PCT/KR2023/013040

§ 371 Date: Jan. 7, 2025

(30) Foreign Application Priority Data
Aug. 31, 2022 (KR) 10-2022-0110268
Aug. 30, 2023 (KR) 10-2023-0114834

(51) Int. Cl. A24F 40/46; A24F 40/20; H05B 6/80

(52) U.S. Cl. CPC A24F 40/46; A24F 40/20; H05B 6/802

(57) ABSTRACT

A heater assembly includes an oscillator that generates microwaves in a designated frequency band, and a resonance unit that receives the microwaves generated by the oscillator through a coupler and generates an electric field by resonating the received microwaves, wherein the resonance unit includes a case including a lower surface, an upper surface facing the lower surface, a side surface surrounding an inner space between the lower surface and the upper surface, an accommodation space for accommodating an aerosol generating article, and at least one opening into which the coupler is insertable in a direction from the lower surface toward the inner space, a plurality of plates separated from each other in a peripheral direction of the aerosol generating article accommodated in the accommodation space, and a connection portion connecting the plurality of plates to each other. Also, various other embodiments may be implemented according to the specification.

### TECHNICAL FIELD

Various embodiments according to the present disclosure relate to a heater assembly capable of generating an aerosol by heating an aerosol generating article via a dielectric heating method and an aerosol generating device including the heater assembly.

### BACKGROUND ART

Recently, the demand for alternative methods for overcoming the shortcomings of general cigarettes has increased. For example, there is an increasing demand for a system for generating aerosols by heating a cigarette or an aerosol generating article by using an aerosol generating device, rather than by burning cigarettes.

Microwave heating technology uses the principle of dielectric heating to heat objects. Aerosol generating materials may be quickly heated using the microwave heating technology.

Well-known aerosol generating devices heat aerosol generating materials through a resistance heating method, an induction heating method, and an ultrasonic heating method. However, a preheating speed is relatively slow and the aerosol generating articles are likely to be heated ununiformly.

In addition, some well-known aerosol generating devices heat aerosol generating materials through a dielectric heating method that is simply a microwave radiation method using an antenna. Thus, there is a problem in that the power transmission efficiency is significantly reduced.

### DISCLOSURE

### Technical Problem

Various embodiments according to the present disclosure provide a heater assembly and an aerosol generating device that may heat an aerosol generating article through a dielectric heating method using microwave resonance.

Problems to be solved by embodiments of the present disclosure are not limited to the problems described above, and problems not described above may be clearly understood by a person having ordinary skill in the art to which the embodiments belong from the present specification and the attached drawings.

### Technical Solution

According to an aspect of the present disclosure, a heater assembly includes an oscillator configured to generate microwaves in a designated frequency band, and a resonance unit configured to receive the microwaves generated by the oscillator through a coupler and generate an electric field by resonating the received microwaves, wherein the resonance unit includes a case including a lower surface, an upper surface facing the lower surface, a side surface surrounding an inner space between the lower surface and the upper surface, an accommodation space for accommodating an aerosol generating article, and at least one opening into which the coupler is insertable in a direction from the lower surface toward the inner space, a plurality of plates separated from each other in a peripheral direction of the aerosol generating article accommodated in the accommodation space, and a connection portion connecting the plurality of plates to each other.

According to another aspect of the present disclosure, a heater assembly includes an oscillator configured to generate microwaves in a designated frequency band, and a resonance unit configured to receive the microwaves generated by the oscillator through a coupler and generate an electric field by resonating the received microwaves, wherein the resonance unit includes an outer conductor including a lower surface, an upper surface facing the lower surface, and a side surface surrounding an inner space between the lower surface and the upper surface, and including an accommodation space for accommodating an aerosol generating article, a first inner conductor surrounding one region of the aerosol generating article accommodated in the accommodation space and including at least one opening into which the coupler is able to be inserted, and a second inner conductor surrounding another region of the aerosol generating article accommodated in the accommodation space.

According to another aspect of the present disclosure, an aerosol generating device includes a housing including an insertion hole into which an aerosol generating article is inserted, and a heater assembly configured to heat the aerosol generating article inserted through the insertion hole, wherein the heater assembly includes an oscillator configured to generate microwaves in a designated frequency band, and a resonance unit configured to receive the microwaves generated by the oscillator through a coupler and generate an electric field by resonating the received microwaves, the resonance unit includes a case including a lower surface, an upper surface facing the lower surface, a side surface surrounding an inner space between the lower surface and the upper surface, an accommodation space for accommodating the aerosol generating article, and at least one opening into which the coupler is insertable in a direction from the lower surface toward the inner space, a plurality of plates separated from each other in a peripheral direction of the aerosol generating article accommodated in the accommodation space, and a connection portion connecting the plurality of plates to each other.

### Advantageous Effects

According to various embodiments of the present disclosure, an oscillation module including a coupler and an oscillator is arranged on a lower surface of a resonance unit, and accordingly, designs of a heater assembly and an aerosol generating device may be changed in various ways.

Also, according to an arrangement structure of the oscillation module of the present disclosure, there is an advantage in that an aerosol generating device may be reduced in size and aesthetics of the aerosol generating device may be improved.

However, effects of the embodiments are not limited to the effects described above, and effects that are not described may be clearly understood by those skilled in the art to which the embodiments belong from the present specification and the attached drawings.

### DESCRIPTION OF DRAWINGS

FIG. 1 is a perspective view of an aerosol generating device according to an embodiment.

FIG. 2 is an internal block diagram of an aerosol generating device according to an embodiment.

FIG. 3 is an internal block diagram of a dielectric heating unit of FIG. 2.

FIG. 4 is a perspective view of a heater assembly according to an embodiment.

FIG. 5 is a cross-sectional view of the heater assembly of FIG. 4.

FIG. 6 is a schematic perspective view of a heater assembly according to another embodiment.

FIG. 7 is a perspective view schematically illustrating a heater assembly according to another embodiment.

FIG. 8A is a cross-sectional view of a heater assembly according to an embodiment.

FIG. 8B is a cross-sectional view of the heater assembly of FIG. 8A in which a resonance unit is coupled to an oscillator.

FIG. 9A is a cross-sectional view of a heater assembly according to another embodiment.

FIG. 9B is a cross-sectional view of the heater assembly of FIG. 9A in which a resonance unit is combined with an oscillator.

FIG. 10A is a cross-sectional view of a heater assembly according to another embodiment.

FIG. 10B is a cross-sectional view of the heater assembly of FIG. 10A in which a resonance unit is combined with an oscillator.

### MODE FOR INVENTION

Hereinafter, embodiments disclosed in this specification will be described in detail with reference to the accompanying drawings, and identical or similar components will be assigned the same reference numbers, regardless of the drawing symbols, and redundant explanations will be omitted.

The suffixes “module” and “unit” used in this description are assigned or used interchangeably solely for the convenience of drafting the specification and do not themselves have distinct meanings or roles.

Also, in describing the embodiments disclosed in this specification, detailed descriptions of well-known technologies may be omitted if it is determined that they could obscure the essence of the embodiments disclosed herein. Additionally, the accompanying drawings are provided merely to facilitate the understanding of the embodiments disclosed in this specification, and the technical spirit disclosed herein is not limited by the drawings. It should be understood that all modifications, equivalents, and substitutes that fall within the spirit and scope of this disclosure are included.

Terms including ordinal numbers, such as first, second, etc., may be used to describe various components, but the components are not limited by the terms. The above terms are used solely to distinguish one component from another.

When a component is referred to as being “connected” or “coupled” to another component, it should be understood that the component may be directly connected or coupled to the other component, or there may be intervening components in between. On the other hand, when a component is referred to as being “directly connected” or “directly coupled” to another component, it should be understood that there are no intervening components in between.

Singular expressions include plural expressions unless the context clearly indicates otherwise.

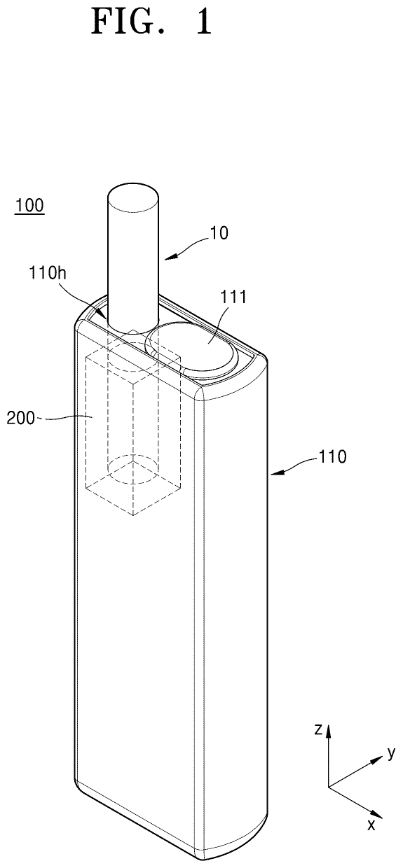

FIG. 1 is a perspective view of an aerosol generating device according to an embodiment.

Referring to FIG. 1, an aerosol generating device 100 according to an embodiment may include a housing 110 for accommodating an aerosol generating article 10 and a heater assembly 200 for heating the aerosol generating article 10 accommodated in the housing 110.

The housing 110 may form the overall exterior of the aerosol generating device 100, and components of the aerosol generating device 100 may be arranged in an inner space (or a ‘mounting space’) of the housing 110. For example, the heater assembly 200, a battery, a processor, and/or a sensor may be arranged in the inner space of the housing 110, but the components arranged in the inner space are not limited thereto.

An insertion hole 110h may be formed in a portion of the housing 110, and at least a portion of the aerosol generating article 10 may be inserted into the housing 110 through the insertion hole 110h. For example, the insertion hole 110h may be formed in a portion of an upper surface (e.g., a surface in a z direction) of the housing 110, but the position of the insertion hole 110h is not limited thereto. In another embodiment, the insertion hole 110h may be formed in a portion of a side surface (e.g., a surface in an x direction) of the housing 110.

The heater assembly 200 may be arranged in the inner space of the housing 110 and heat the aerosol generating article 10 inserted into or accommodated in the housing 110 through the insertion hole 110h. For example, the heater assembly 200 may be positioned to surround at least a portion of the aerosol generating article 10 inserted into or accommodated in the housing 110, thus heating the aerosol generating article 10.

According to an embodiment, the heater assembly 200 may heat the aerosol generating article 10 by using a dielectric heating method. In the present specification, the term ‘dielectric heating method’ refers to a method of heating a dielectric material, which is a heating object, by using resonance of microwaves and/or an electric field (which may include a magnetic field) of the microwaves. Microwaves are energy sources used to heat a heating object and are generated by high-frequency power, and thus, the term ‘microwave’may hereinafter be used interchangeably with microwave power.

Charges or ions in a dielectric material included in the aerosol generating article 10 may vibrate or rotate because of microwave resonance within the heater assembly 200, and frictional heat generated during the vibration or rotation of the charges or ions may cause heat to be generated from the dielectric material such that the aerosol generating article 10 may be heated.

As the aerosol generating article 10 is heated by the heater assembly 200, an aerosol may be generated from the aerosol generating article 10. In the present specification, the term ‘aerosol’ may refer to gaseous particles generated from a mixture of vapor and air that are produced as the aerosol generating article 10 is heated.

The aerosol generated from the aerosol generating article 10 may pass through the aerosol generating article 10 or may be discharged to the outside of the aerosol generating device 100 through an empty space between the aerosol generating article 10 and the insertion hole 110h. A user may place their mouth on a portion of the aerosol generating article 10 exposed to the outside of the housing 110 and may inhale the aerosol discharged from the aerosol generating device 100, thereby smoking.

The aerosol generating device 100 according to an embodiment may further include a cover 111 that is movably arranged on the housing 110 to open or close the insertion hole 110h. For example, the cover 111 may be slidably coupled to the upper surface of the housing 110 and may expose the insertion hole 110h to the outside of the aerosol generating device 100 or cover the insertion hole 110h to prevent the same from being exposed to the outside of the aerosol generating device 100.

In an embodiment, the cover 111 may allow the insertion hole 110h to be exposed to the outside of the aerosol generating device 100 at a first position (or ‘open position’). When the aerosol generating device 100 is externally exposed, the aerosol generating article 10 may be inserted into the housing 110 through the insertion hole 110h.

In another embodiment, the cover 111 covers the insertion hole 110h at a second position (or ‘closed position’) to prevent the insertion hole 110h from being exposed outside the aerosol generating device 100. In this case, the cover 111 may prevent external foreign materials from entering the heater assembly 200 through the insertion hole 110h when the aerosol generating device 100 is not in use.

FIG. 1 only shows the aerosol generating device 100 for heating the aerosol generating article 10 in a solid state, but the aerosol generating device 100 is not limited thereto.

An aerosol generating device according to another embodiment may generate an aerosol by heating an aerosol generating material in a liquid or gel state by using the heater assembly 200, rather than heating the aerosol generating article 10 in a solid state.

An aerosol generating device according to another embodiment may include a heater assembly 200 that heats an aerosol generating article 10 and a cartridge (or ‘vaporizer’) that contains an aerosol generating material in a liquid or gel state and heats the same. After moving to the aerosol generating article 10 along an airflow passage connecting the cartridge and the aerosol generating article 10, the aerosol generated from the aerosol generating material may be mixed with the aerosol produced by the aerosol generating article 10 and then delivered to the user via the aerosol generating article 10.

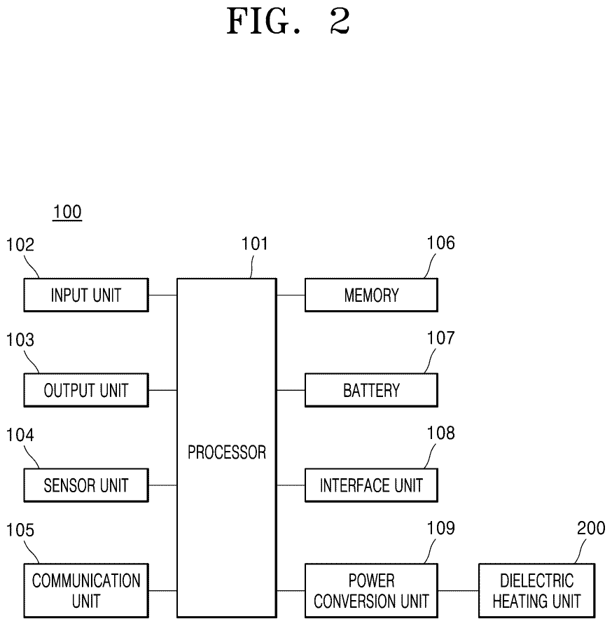

FIG. 2 is an internal block diagram of an aerosol generating device according to an embodiment.

Referring to FIG. 2, the aerosol generating device 100 may include an input unit 102, an output unit 103, a sensor unit 104, a communication unit 105, a memory 106, a battery 107, an interface unit 108, a power converter 109, and a dielectric heating unit 200.

The input unit 102 may receive a user input. For example, the input unit 102 may be a single pressure-type push button. As another example, the input unit 102 may be a touch panel including at least one touch sensor. The input unit 102 may transmit an input signal to a processor 101. The processor 101 may supply power to the dielectric heating unit 200 based on a user input or control the output unit 103 to output a user notification.

The output unit 103 may output information on a state of the aerosol generating device 100. The output unit 103 may output a charge/discharge state of the battery 107, a heating state of the dielectric heating unit 200, an insertion state of the aerosol generating article 10, and error information of the aerosol generating device 100. To this end, the output unit 103 may include a display, a haptic motor, and a sound output unit.

The sensor unit 104 may sense a state of the aerosol generating device 100 and a state around the aerosol generating device 100 and may transmit sensed information to the processor 101. Based on the sensed information, the processor 101 may control the aerosol generating device 100 to perform various functions, such as heating control of the dielectric heating unit 200, limiting smoking, determining whether the aerosol generating article 10 is inserted, and displaying a notification.

The sensor unit 104 may include a temperature sensor, a puff sensor, and an insertion detection sensor.

The temperature sensor may sense an internal temperature of the dielectric heating unit 200 in a non-contact manner or may contact the dielectric heating unit 200 to thus directly obtain a temperature of a resonator. According to an embodiment, the temperature sensor may also sense the temperature of the aerosol generating article 10. In addition, the temperature sensor may be arranged adjacent to the battery 107 and obtain the temperature thereof. The processor 101 may control the power supplied to the dielectric heating unit 200, based on temperature information of the temperature sensor.

The puff sensor may detect a user's puff. The puff sensor may sense a user's puff on the basis of at least one of a temperature change, a flow change, a power change, and a pressure change. The processor 101 may control the power supplied to the dielectric heating unit 200, based on puff information from the puff sensor. For example, the processor 101 may count the number of puffs, and when the number of puffs reaches a preset maximum number of puffs, the processor 101 may block the power supplied to the dielectric heating unit 200. As another example, the processor 101 may block the power supplied to the dielectric heating unit 200 when no puffs are sensed for a certain period of time.

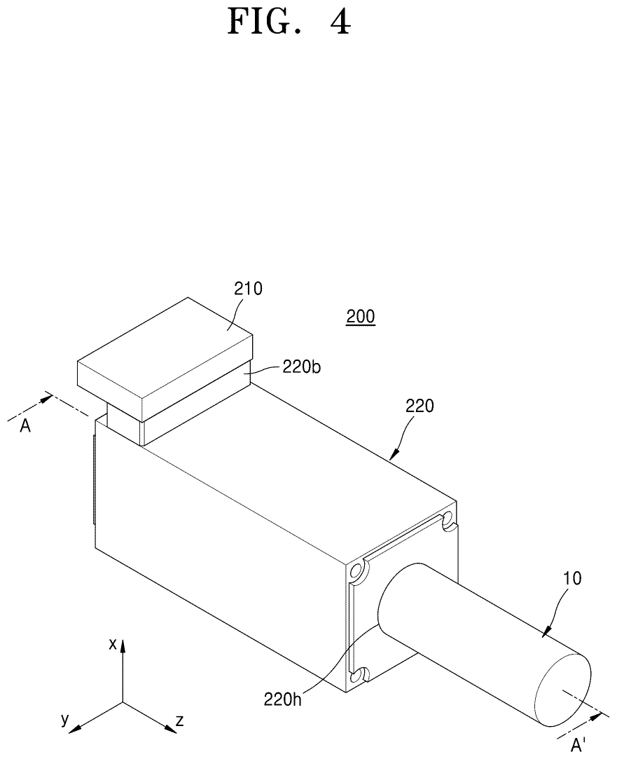

The insertion detection sensor may be arranged inside or adjacent to an accommodation space (220h of FIG. 4) and thus may detect the insertion and removal of the aerosol generating article 10 accommodated in the insertion hole 110h. For example, the insertion detection sensor may include an inductive sensor and/or a capacitance sensor. When the aerosol generating article 10 is inserted into the insertion hole 110h, the processor 101 may supply power to the dielectric heating unit 200.

According to an embodiment, the sensor unit 104 may additionally include a reuse detection sensor, a motion detection sensor, a humidity sensor, a barometric pressure sensor, a magnetic sensor, a cover detachment detection sensor, a location sensor (a global positioning system (GPS)), a proximity sensor, and the like. Because a function of each of sensors may be intuitively inferred from the name of the sensor, a detailed description thereof may be omitted.

The communication unit 105 may include at least one communication module for communication with external electronic device. The processor 101 may control the communication unit 105 and transmit information regarding the aerosol generating device 100 to the external electronic device. Alternatively, the processor 101 may receive information from the external electronic device through the communication unit 105 and control the components included in the aerosol generating device 100. For example, information exchanged between the communication unit 105 and the external electronic device may include user authentication information, firmware update information, and user's smoking pattern information.

The memory 106 may be a hardware component that stores various types of data processed in the aerosol generating device 100 and may store data processed and data to be processed by the processor 101. For example, the memory 106 may store an operation time of the aerosol generating device 100, the maximum number of puffs, the current number of puffs, at least one temperature profile, data on a user's smoking pattern, etc.

The battery 107 may supply power to the dielectric heating unit 200 to heat the aerosol generating article 10. In addition, the battery 107 may supply power required for operations of other components included in the aerosol generating device 100. The battery 110 may be a rechargeable battery or a separable and detachable battery.

The interface unit 108 may include a connection terminal that may be physically connected to the external electronic device. The connection terminal may include at least one of a High-Definition Multimedia Interface (HDMI) connector, a Universal Serial Bus (USB) connector, a Secure Digital (SD) card connector, and an audio connector (e.g., a headphone connector) or a combination thereof. The interface unit 108 may exchange information with the external electronic device through the connection terminal or charge power.

The power converter 109 may convert direct current power from the battery 107 into alternating current power. In addition, the power converter 109 may supply the converted alternating current power to the dielectric heating unit 200. The power converter 109 may be an inverter including at least one switching device, and the processor 101 may control the ON/OFF state of the switching device included in the power converter 109 and convert direct current power into alternating current power. The power converter 109 may be implemented as a full bridge or a half bridge.

The dielectric heating unit 200 may heat the aerosol generating article 10 by using a dielectric heating method. The dielectric heating unit 200 may correspond to the heater assembly 200 of FIG. 1.

The dielectric heating unit 200 may use microwaves and/or an electric field of microwaves (hereinafter, referred to as microwaves or microwave power when no classification is required) to heat the aerosol generating article 10. The heating method of the dielectric heating unit 200 may include heating a heating object by producing microwaves in a resonance structure, rather than radiating microwaves by using an antenna. The resonance structure is described below with reference to FIG. 4 and subsequent figures.

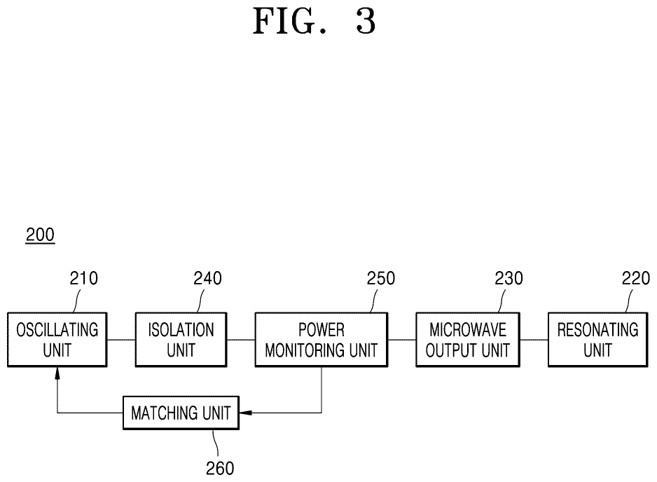

The dielectric heating unit 200 may output high-frequency microwaves to a resonating unit (220 of FIG. 3). Microwaves may be power in an Industrial Scientific and Medical (ISM) band allowed for heating, but one or more embodiments are not limited thereto. The resonating unit 220 may be designed by taking the wavelength of the microwaves into account to facilitate the resonance of the microwaves within the resonating unit 220.

The aerosol generating article 10 may be inserted into the resonating unit 220, and a dielectric material in the aerosol generating article 10 may be heated by the resonating unit 220. For example, the aerosol generating article 10 may include a polar substance, and molecules in the polar substance may be polarized in the resonating unit 220. The molecules may vibrate or rotate due to polarization, and the aerosol generating article 10 may be heated by frictional heat generated during the vibration or rotation. The dielectric heating unit 200 is described in more detail with reference to FIG. 3.

The processor 101 may control general operations of the aerosol generating device 100. The processor 101 may be implemented as an array of a plurality of logic gates or as a combination of a general-purpose microprocessor and a memory in which a program executable in the microprocessor is stored. Also, the processor 101 may be implemented in other forms of hardware.

The processor 101 may control direct current power supplied from the battery 107 to the power converter 109 and/or alternating current power supplied from the power converter 109 to the dielectric heating unit 200, according to power required for the dielectric heating unit 200. In an embodiment, the aerosol generating device 100 may include a converter that increases or decreases direct current power, and the processor 101 may control the converter to adjust the magnitude of the direct current power. Additionally, the processor 101 may adjust a switching frequency and a duty ratio of the switching device included in the power converter 109, thus controlling the alternating current power supplied to the dielectric heating unit 200.

The processor 101 may control microwave power of the dielectric heating unit 200 and a resonance frequency of the dielectric heating unit 200, thereby controlling a heating temperature of the aerosol generating article 10. Therefore, an oscillating unit 210, an isolation unit 240, a power monitoring unit 250, and a matching unit 260 of FIG. 3 described below may be some components of the processor 101.

The processor 101 may control microwave power of the dielectric heating unit 200 based on temperature profile information stored in the memory 106. In other words, a temperature profile may include information regarding a target temperature of the dielectric heating unit 200 over time, and the processor 101 may control the microwave power of the dielectric heating unit 200 over time.

The processor 101 may adjust the frequency of the microwaves to make the resonance frequency of the dielectric heating unit 200 uniform. The processor 101 may track a change in the resonance frequency of the dielectric heating unit 200 in real time as the heating object is heated, and may control the dielectric heating unit 200 to output a microwave frequency according to the changing resonance frequency. In other words, the processor 101 may adjust the microwave frequency in real time, irrespective of the temperature profile stored in advance.

FIG. 3 is an internal block diagram of the dielectric heating unit of FIG. 2.

Referring to FIG. 3, the dielectric heating unit 200 may include the oscillating unit 210, the isolation unit 240, the power monitoring unit 250, the matching unit 260, a microwave output unit 230, and the resonating unit 220.

The oscillating unit 210 may receive alternating current power from the power converter 109 and generate high-frequency microwave power. According to an embodiment, the power converter 109 may be included in the oscillating unit 210. Microwave power may be selected from the frequency bands, such as 915 MHz, 2.45 GHz, and 5.8 GHz, which are included in the ISM bands.

The oscillating unit 210 may include a solid-state-based RF generating device and generate microwave power by using the same. The solid-state-based RF generating device may be realized as a semiconductor. When the oscillating unit 210 is implemented as a semiconductor, the dielectric heating unit 200 may be miniaturized, and the lifespan of the device may be extended.

The oscillating unit 210 may output microwave power to the resonating unit 220. The oscillating unit 210 may include a power amplifier that increases or decreases the microwave power, and the power amplifier may adjust the magnitude of the microwave power under the control by the processor 101. For example, the power amplifier may decrease or increase the amplitude of microwaves. As the amplitude of microwaves is adjusted, the microwave power may also be adjusted.

The processor 101 may adjust the magnitude of the microwave power output from the oscillating unit 210, based on the temperature profile stored in advance. For example, the temperature profile may include target temperature information according to the preheating section and the smoking section, and the oscillating unit 210 may supply microwave power at a first power level in the preheating section and supply microwave power at a second power level in the smoking section, wherein the second power level is less than the first power level.

The isolation unit 240 may block the microwave power that is input to the oscillating unit 210 from the resonating unit 220. Most of the microwave power that is output from the oscillating unit 210 is absorbed into the heating object, but depending on the heating characteristics of the heating object, part of the microwave power may be reflected from the heating object and transmitted back towards the oscillating unit 210. This occurs due to a change in the impedance measured from the oscillating unit 210 to the resonating unit 220 as polar molecules are depleted while the heating object is heated. The description that ‘the impedance from the oscillating unit 210 to the resonating unit 220 changes’ may be the same as the description that ‘the resonance frequency of the resonating unit 220 changes.’ When the microwave power reflected from the resonating unit 220 is input to the oscillating unit 210, the oscillating unit 210 may not only malfunction but also fail to achieve expected output performance. The isolation unit 240 may not redirect the microwave power, which is reflected from the resonating unit 220, to the oscillating unit 210 and may guide the microwave power in a certain direction to absorb the same. To this end, the isolation unit 240 may include a circulator and a dummy load.

The power monitoring unit 250 may monitor the microwave power, which is output from the oscillating unit 210, and the reflected microwave power, which is reflected from the resonating unit 220, respectively. The power monitoring unit 250 may transmit information regarding the microwave power and the reflected microwave power to the matching unit 260.

The matching unit 260 may match the impedance measured from the oscillating unit 210 to the resonating unit 220 with the impedance measured from the resonating unit 220 to the oscillating unit 210 to minimize the reflected microwave power. Impedance matching may indicate that the frequency of the oscillating unit 210 aligns with the resonance frequency of the resonating unit 220. Therefore, the matching unit 260 may vary the frequency of the oscillating unit 210 to match the impedance. In other words, the matching unit 260 may adjust the frequency of the microwave power that is output from the oscillating unit 210 to minimize the reflected microwave power. The impedance matching by the matching unit 260 may be performed in real time regardless of the temperature profile.

The oscillating unit 210, the isolation unit 240, the power monitoring unit 250, and the matching unit 260 described above may be distinct from the microwave output unit 230 and the resonating unit 220 below and may be implemented as microwave sources in the form of chips. According to an embodiment, the oscillating unit 210, the isolation unit 240, the power monitoring unit 250, and the matching unit 260 may be implemented as some components of the processor 101.

The microwave output unit 230 may be a component configured to input the microwave power to the resonating unit 220 and may correspond to a coupler shown in FIG. 3 and subsequent figures. The microwave output unit 230 may be implemented in the form of SubMiniature version A (SMA), SubMiniature version B (SMB), Micro Coaxial (MCX), and Micro-Miniature coaxial (MMCX) connectors. The microwave output unit 230 may connect the resonating unit 220 to a chip-shaped microwave source and deliver microwave power generated from the microwave source to the resonating unit 220.

The resonating unit 220 may form microwaves within the resonance structure, thus heating the heating object. The resonating unit 220 may include an accommodation space where the aerosol generating article 10 is accommodated, and the aerosol generating article 10 may be exposed to microwaves and dielectric-heated. For example, the aerosol generating article 10 may include a polar substance, and molecules in the polar substance may be polarized by the microwaves within the resonating unit 220. The molecules may vibrate or rotate due to polarization, and the aerosol generating article 10 may be heated by frictional heat generated during the vibration or rotation.

The resonating unit 220 may include at least one internal conductor to resonate microwaves, and depending on the arrangement, thickness, length, and the like of the internal conductor, the microwaves may resonate within the resonating unit 220.

The resonating unit 220 may be designed by taking the wavelength of the microwaves into account to facilitate the resonance of the microwaves within the resonating unit 220. For the resonance of the microwaves within the resonating unit 220, there is a need for a closed end/short end with a closed cross-section and an open end with at least one open portion on the opposite side. In addition, the length between the closed end/short end and the open end must be set to an integer multiple of ¼ of the microwave wavelength. The resonating unit 220 selects a length equal to ¼ of the microwave wavelength to ensure device miniaturization. In other words, the length between the closed end/short end and the open end of the resonating unit 220 may be set to ¼ of the microwave wavelength.

The resonating unit 220 may include a dielectric accommodation space. The dielectric accommodation space is separate from the accommodation space of the aerosol generating article 10 and contains a material that may reduce the size of the resonating unit 220 by changing the overall resonance frequency of the resonating unit 220. In an embodiment, dielectric materials with low microwave absorption may be accommodated in the dielectric accommodation space. Such accommodation is intended to prevent energy, which should be delivered to the heating object, from being transferred to the dielectric materials and causing the dielectric materials to generate heat. Microwave absorbance may be expressed as a loss tangent that is a ratio of a real part of a complex dielectric constant to an imaginary part thereof. In an embodiment, dielectric materials with a loss tangent of a preset value or less may be accommodated in the dielectric accommodation space 227, and the preset value may be 1/100. For example, the dielectric material may include at least any one of quartz, tetrafluoroethylene, and aluminum oxide, or a combination thereof, but one or more embodiments are not limited thereto.

FIG. 4 is a perspective view of a heater assembly according to an embodiment.

Referring to FIG. 4, the heater assembly 200 according to an embodiment may include the oscillating unit 210 and the resonating unit 220. FIG. 4 may show an embodiment of the heater assembly 200 and the dielectric heating unit 200 described above, and repeated description is omitted.

The oscillating unit 210 may generate microwaves in a designated frequency band as power is supplied. The microwaves generated by the oscillating unit 210 may be transferred to the resonating unit 220 through a coupler (not shown).

The resonating unit 220 may include the accommodation space 220h for accommodating at least a portion of the aerosol generating article 10 and resonate the microwaves generated by the oscillating unit 210, thus heating the aerosol generating article 10 by using the dielectric heating method. For example, charges of glycerin included in the aerosol generating article 10 may vibrate or rotate due to the resonance of the microwaves, and frictional heat generated during such vibration or rotation may cause heat to be produced in the glycerin such that aerosol generating article 10 may be heated.

According to an embodiment, the resonating unit 220 may include a material with low microwave absorption to prevent the microwaves, generated by the oscillating unit 210, from being absorbed into the resonating unit 220.

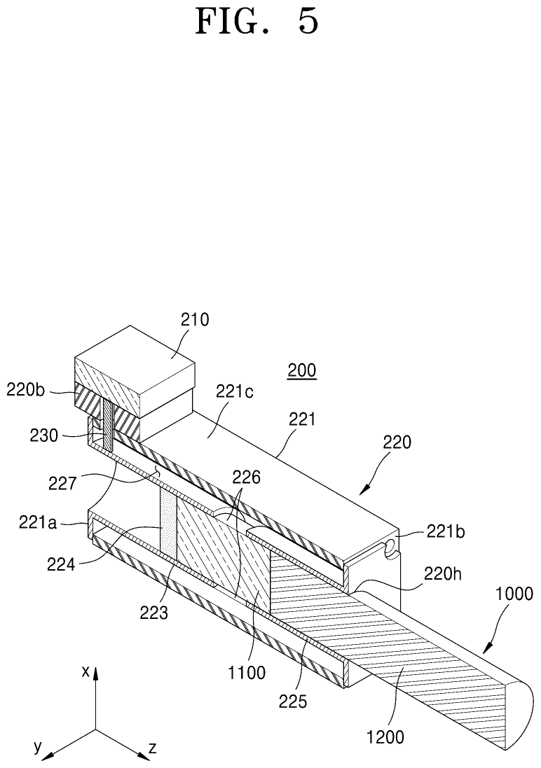

Hereinafter, the detailed structure of the resonating unit 220 of the heater assembly 200 is described with reference to FIG. 5.

FIG. 5 is a cross-sectional view of the heater assembly of FIG. 4. FIG. 5 shows a cross-section of the heater assembly 200 of FIG. 4, taken along a direction A-A′.

Referring to FIG. 5, the heater assembly 200 according to an embodiment may include the oscillating unit 210, the resonating unit 220, and a coupler 230. The components of the heater assembly 200 may be the same as or similar to at least one of the components of the heater assembly 200 of FIG. 4, and repeated description is omitted hereinafter.

The oscillating unit 210 may generate microwaves in a designated frequency band as an alternating current voltage is applied, and the microwaves generated by the oscillating unit 210 may be delivered to the resonating unit 220 through the coupler 230.

According to an embodiment, the oscillating unit 210 may be fixed to the resonating unit 220 to prevent separation from the resonating unit 220 while the aerosol generating device is used. In an embodiment, the oscillating unit 210 may be supported by brackets 220b protruding along the x direction on a portion of the resonating unit 220, thus being fixed to the resonating unit 220. In another embodiment, the oscillating unit 210 may be fixed to a portion of the resonating unit 220 without the brackets 220b.

In the drawing, the oscillating unit 210 is fixed to a portion of the resonating unit 220 that faces the x direction, but the position of the oscillating unit 210 is not limited thereto. In another embodiment, the oscillating unit 210 may be fixed to another portion of the resonating unit 220 that faces in the −z direction.

The resonating unit 220 may be arranged to surround at least a portion of the aerosol generating article 10 inserted into the aerosol generating device and may heat the aerosol generating article 10 by using the microwaves generated by the oscillating unit 210. For example, dielectric materials included in the aerosol generating article 10 may generate heat because of the electric field generated in the resonating unit 220 due to the microwaves, and the aerosol generating article 10 may be heated by the heat generated in the dielectric materials.

According to an embodiment, the aerosol generating article 10 may include a tobacco rod 11 and a filter rod 12.

The tobacco rod 11 may include an aerosol generating material and may be formed as a sheet, a strand, or a pipe tobacco formed of tiny bits cut from a tobacco sheet. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 11 may include other additives, such as flavors, a wetting agent, and/or organic acid. Also, the tobacco rod 11 may include a flavored liquid, such as menthol or a moisturizer, which is injected to the tobacco rod 11.

The filter rod 12 may include a cellulose acetate filter. Shapes of the filter rod 12 are not limited. For example, the filter rod 12 may include a cylinder-type rod or a tube-type rod having a hollow inside. Also, the filter rod 12 may include a recess-type rod. When the filter rod 12 includes a plurality of segments, at least one of the plurality of segments may have a different shape.

At least part (e.g., glycerin) of the aerosol generating material included in the aerosol generating article 10 may be a dielectric material with polarity in an electric field, and the at least part of the aerosol generating material may generate heat in a dielectric heating method, thereby heating the aerosol generating article 10.

According to an embodiment, the resonating unit 220 may include an outer conductor 221, a first internal conductor 223, and a second internal conductor 225.

The outer conductor 221 may form the overall exterior of the resonating unit 220 and have a shape with a hollow space therein; thus, the components of the resonating unit 220 may be arranged inside the outer conductor 221. The outer conductor 221 may include the accommodation space 220h where the aerosol generating article 10 may be accommodated, and the aerosol generating article 10 may be inserted into the outer conductor 221 through the accommodation space 220h.

According to an embodiment, the outer conductor 221 may include a first surface 221a, a second surface 221b facing the first surface 221a, and side surfaces 221c surrounding an empty space between the first surface 221a and the second surface 221b. At least a portion (e.g., the first internal conductor 223 and the second internal conductor 225) of the components of the resonating unit 220 may be arranged in the inner space of the resonating unit 220 formed by the first surface 221a, the second surface 221b, and the side surfaces 221c.

The first internal conductor 223 may be shaped as a hollow cylinder extending in a direction towards the inner space of the outer conductor 221 from the first surface 221a of the outer conductor 221.

According to an embodiment, a portion of the first internal conductor 223 may contact the coupler 230 connected to the oscillating unit 210, and the microwaves generated by the oscillating unit 210 may be transferred to the first internal conductor 223 through the coupler 230. For example, the coupler 230 may penetrate the outer conductor 221 and may be arranged so that one end of the coupler 230 contacts the oscillating unit 210 and the other end contacts a portion of the first internal conductor 223, and the microwaves generated by the oscillating unit 210 may be transferred to the first internal conductor 223 through the coupler 230.

In this case, the coupler 230 may be arranged not to contact the outer conductor 221 but to penetrate the same to transfer the microwaves, but the arrangement of the coupler 230 is not limited thereto as long as the microwaves generated by the oscillating unit 210 may be delivered to the first internal conductor 223.

A first area formed between the outer conductor 221 and the first internal conductor 223 may function as a ‘first resonator’ that generates an electric field through microwave resonance. The first area may refer to the space formed by the first surface 221a and the side surfaces 221c of the outer conductor 221 and the first internal conductor 223, and within the first area, an electric field may be generated as the microwaves transmitted through the coupler 230 resonate. The second internal conductor 225 may be shaped as a hollow cylinder extending in a direction towards the inner space of the outer conductor 221 from the second surface 221b of the outer conductor 221. The second internal conductor 225 may be spaced apart from the first internal conductor 223 by a certain distance within the inner space of the outer conductor 221, and there may be a gap between the first internal conductor 223 and the second internal conductor 225. A second area formed between the outer conductor 221 and the second internal conductor 225 may function as a ‘second resonator’ that generates an electric field through microwave resonance. The second internal conductor 225 may be coupled to the first internal conductor 223 (e.g., capacitive coupling), and when an electric field is generated in the first area because of the above coupling relationship, an induced electric field may be generated even in the second area. In the present specification, the term ‘capacitive coupling’ may refer to a coupling relationship in which energy may be transferred due to capacitance between two conductors.

For example, as the microwaves generated by the oscillating unit 210 are delivered to the first internal conductor 223, an electric field may be generated in the first area due to resonance, and an induced electric field may be generated in the second area that is formed by the second internal conductor 225 coupled to the outer conductor 221 and the first internal conductor 223.

According to an embodiment, the first area and the second area of the resonating unit 220 may operate as resonators with a length equal to a quarter of the microwave wavelength A.

In an embodiment, one end of the first area (e.g., an end in the −z direction) may be formed as a closed end/short end as the cross-section of the first area is closed by the first surface 221a of the outer conductor 221, and the other end of the first area (e.g., an end in the z direction) may be formed as an open end because the first surface 221a is not present, leaving the cross-section open. As another example, one end of the second area (e.g., an end in the −z direction) may be formed as an open end as the cross-section is open, and the other end of the second area (e.g., an end in the z direction) may be formed as a closed end/short end as the cross-section of the second area is closed by the second surface 221b of the outer conductor 221.

In other words, when viewed in an xz plane, the first area and the second area may each include a closed end/short end and an open end and may be shaped overall in the form of “E”, and based on the above-described structure, the first area and the second area may each function as a resonator with a length of a quarter of the microwave wavelength.

According to an embodiment, the first internal conductor 223 and the second internal conductor 225 are formed to have the same length with respect to the z axis, and thus, the first area and the second area may be symmetrically arranged; however, one or more embodiments are not limited thereto.

The aerosol generating article 10 inserted into the inner space of the outer conductor 221 through the accommodation space 220h may be surrounded by the first internal conductor 223 and the second internal conductor 225 and may be heated by using a dielectric heating method.

At least a portion of the electric field, which is generated in the first area and/or the second area due to microwave resonance, may propagate towards the inside of the first internal conductor 223 and/or the second internal conductor 225 through the gap 226 between the first internal conductor 223 and/or the second internal conductor 225, and the aerosol generating article 10 surrounded by the first internal conductor 223 and the second internal conductor 225 may be heated by the propagating electric field. For example, dielectric materials included in the aerosol generating article 10 may generate heat because of the electric field propagating through the gap 226, and the aerosol generating article 10 may be heated by the heat generated in the dielectric materials.

The heater assembly 200 according to an embodiment may be designed such that the diameters first internal conductor 223 and the second internal conductor 225 may each fall below a designated value, thereby preventing the electric field, which propagates into the first internal conductor 223 and/or the second internal conductor 225, from leaking to the outside of the heater assembly 200 or the resonating unit 220. In the present specification, the term ‘designated value’ may refer to a diameter value at which the electric field starts leaking to the outside of the first internal conductor 223 and/or the second internal conductor 225. For example, when the diameter of the first internal conductor 223 and/or the second internal conductor 225 has a designated value or more, part of the electric field entering the first internal conductor 223 and/or the second internal conductor 225 may leak to the outside of the resonating unit 220. On the contrary, the heater assembly 200 according to an embodiment may prevent the electric field from propagating to the outside of the resonating unit 220 according to the structure in which the diameters of the first internal conductor 223 and the second internal conductor 225 are less than the designated value, thereby preventing the electric field from leaking to the outside of the heater assembly 200 or the resonating unit 220 without a separate blocking member.

According to an embodiment, when the aerosol generating article 10 is inserted into the resonating unit 220 through the accommodation space 220h, the tobacco rod 11 of the aerosol generating article 10 may be arranged at a position corresponding to the gap 226 between the first internal conductor 223 and the second internal conductor 225.

As the electric field generated in the first area and the electric field generated in the second area are introduced to the first internal conductor 223 and/or the second internal conductor 225 through the gap 226, the strongest electric field may be generated in a peripheral area of the gap 226 within the inner area of the resonating unit 220.

In the heater assembly 200 according to an embodiment, the tobacco rod 11 including dielectric materials generating heat due to the electric field is arranged at the position corresponding to the gap 226 where the electric field is the strongest, and thus, the heating efficiency (or ‘dielectric heating efficiency’) of the heater assembly 200 may be improved.

According to an embodiment, the resonating unit 220 may further include a closing unit 224 that is located inside the first internal conductor 223, closes a cross-section of the first internal conductor 223, and restricts a flow direction of the aerosol generated from the aerosol generating article 10. For example, the closing unit 224 may block the flow of the aerosol, which is generated from the aerosol generating article 10, in the −z direction by closing the cross-section of the first internal conductor 223.

When the aerosol generated from the aerosol generating article 10 or droplets, which are generated as the aerosol is liquefied, flow in the −z direction and enter other components of the aerosol generating device (e.g., the aerosol generating device 100 of FIG. 1), malfunction or damage to the components of the aerosol generating device may occur. On the contrary, the heater assembly 200 according to an embodiment restricts the flow direction of the aerosol by using the closing unit 224, thereby preventing malfunction or damage to the components of the aerosol generating device that is caused by the aerosol or droplets.

According to an embodiment, the resonating unit 220 may further include the dielectric accommodation space 227 for accommodating dielectric materials. The dielectric accommodation space 227 may refer to an empty space between the outer conductor 221, the first internal conductor 223, and the second internal conductor 225, and dielectric materials with low microwave absorption may be accommodated in the dielectric accommodation space 227. For example, the dielectric material may include at least any one of quartz, tetrafluoroethylene, and aluminum oxide, or a combination thereof, but one or more embodiments are not limited thereto.

In the heater assembly 200 according to an embodiment, the dielectric materials may be arranged in the dielectric accommodation space 227, and thus, an electric field such as the resonating unit 220 without dielectric materials may be generated while reducing the overall size of the resonating unit 220. That is, in the heater assembly 200 according to an embodiment, the size of the resonating unit 220 may be reduced by using the dielectric materials arranged in the dielectric accommodation space 227 to decrease the mounting space required for the resonating unit 220 in the aerosol generating device, resulting in the miniaturization of the aerosol generating device.

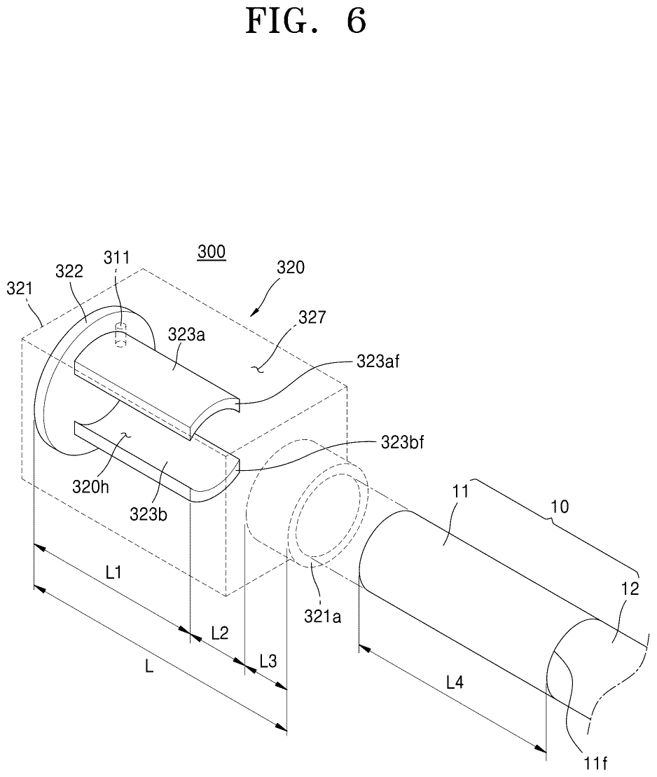

FIG. 6 is a schematic perspective view of a heater assembly according to another embodiment.

A heater assembly 300 shown in the embodiment of FIG. 6 may include a resonating unit 320 that generates microwave resonance and a coupler 311 that supplies microwaves to the resonating unit 320.

The resonating unit 320 may include a case 321, a plurality of plates 323a and 323b, and a connecting portion 322 that connects the case 321 to the plates 323a and 323b.

The coupler 311 may deliver microwaves to at least one of the plates 323a and 323b to generate microwave resonance in the resonating unit 320.

The resonating unit 320 may surround at least a portion of the aerosol generating article 10 inserted into the aerosol generating device. The coupler 311 may provide the resonating unit 320 with the microwaves generated by an oscillating unit (not shown). When the microwaves are supplied to the resonating unit 320, microwave resonance occurs in the resonating unit 320 such that the resonating unit 320 may heat the aerosol generating article 10. For example, the dielectric materials included in the aerosol generating article 10 may generate heat due to the electric field generated within the resonating unit 220 due to the microwaves, and the aerosol generating article 10 may be heated by the heat generated in the dielectric materials.

The case 321 of the resonating unit 320 functions as the ‘outer conductor.’ Because the case 321 has an empty hollow shape, the components of the resonating unit 320 may be arranged within the case 321.

The case 321 may include an accommodation space 320h for accommodating the aerosol generating article 10 and an opening 321a through which the aerosol generating article 10 may be inserted. The opening 321a is connected to the accommodation space 320h. Because the opening 321a is open towards the outside of the case 321, the accommodation space 320h is connected to the outside through the opening 321a. Therefore, the aerosol generating article 10 may be inserted into the accommodation space 320h of the case 321 through the opening 321a of the case 321.

The case 321 in the drawing has a square shape, but the shape may vary. For example, the structure of the case 321 may be modified to have various cross-sectional shapes, for example, a rectangle, an oval, or a circle. The case 321 may extend in a direction.

The plurality of plates 323a and 323b functioning as ‘internal conductors’ of the resonating unit 320 may be arranged inside the case 321.

The plates 323a and 323b may be arranged apart from each other along a circumferential direction of the aerosol generating article 10 accommodated in the accommodation space 320h. The plates 323a and 323b may include a first plate 323a arranged to surround a portion of the aerosol generating article 10 and a second plate 323b arranged to surround another portion of the aerosol generating article 10.

The plates 323a and 323b may be connected to the case 321 via the connecting portion 322. In addition, one end of the first plate 323a of the plates 323a and 323b may be connected to one end of the second plate 323b via the connecting portion 322. Therefore, a closed end/short end may be formed at the one end of each of the plates 323a and 323b by the connecting portion 322.

The other end 323af of the first plate 323a of the plates 323a and 323b and the other end 323bf of the second plate 323b may be spaced apart from each other and thus open. Because other ends of the plates 323a and 323b are spaced apart from each other, open ends may be formed at the other ends of the plates 323a and 323b.

As the plates 323a and 323b are connected to the connecting portion 322, a resonator assembly may be completed. The cross-sectional shape of the resonator assembly taken along a lengthwise direction thereof may include a horseshoe shape.

The plates 323a and 323b extend in the lengthwise direction of the aerosol generating article 10. At least a portion of the plates 323a and 323b may be curved to protrude outward from the center of the aerosol generating article 10 in the lengthwise direction thereof.

For example, when the aerosol generating article 10 has a cylindrical shape, the plates 323a and 323b may be curved in a circumferential direction along the outer circumferential surface of the aerosol generating article 10. The radius of curvature of the cross-section of the plates 323a and 323b may be identical to that of the aerosol generating article 10. The radius of curvature of the cross-section of the plates 323a and 323b may be variously modified. For example, the radius of curvature of the cross-section of the plates 323a and 323b may be greater or less than that of the aerosol generating article 10.

According to the structure in which the plates 323a and 323b are curved in the circumferential direction along the outer circumferential surface of the aerosol generating article 10, a more uniform electric field may be formed in the resonating unit 320, and thus, the heater assembly 300 may uniformly heat the aerosol generating article 10.

The open ends at the other ends of the plates 323a and 323b may face the opening 321a of the case 321. The opening 321a of the case 321 may be arranged away from the other ends of the plates 323a and 323b.

The open ends at the other ends of the plates 323a and 323b may be aligned with the opening 321a of the case 321. Therefore, when the aerosol generating article 10 is inserted through the opening 321a of the case 321 and placed in the accommodation space 320h, a portion of the aerosol generating article 10 located in the accommodation space 320h may be surrounded by the plates 323a and 323b.

Two plates, that is, the plates 323a and 323b, may be arranged at opposite locations with respect to the center of the aerosol generating article 10 in the lengthwise direction thereof. One or more embodiments are not limited by the number of plates 323a and 323b, and the number of plates 323a and 323b may be, for example, three or at least four.

The plates 323a and 323b may be arranged symmetrically to each other with respect to the lengthwise direction of the aerosol generating article 10, that is, the central axis in the extension direction of the aerosol generating article 10.

At least one of the plates 323a and 323b may contact the coupler 311 connected to the oscillating unit (not shown). In detail, at least a portion of the first plate 323a may contact the coupler 311. When microwaves are delivered to the first plate 323a through the coupler 311, microwave resonance is formed between the plates 323a and 323b. In addition, microwave resonance is formed not only between the first plate 323a and an upper side plate of the case 321 but also between the second plate 323b and a lower side plate of the case 321. Therefore, electric fields may be generated respectively between the plates 323a and 323b and the connecting portion 322, between the first plate 323a and the upper side plate of the case 321, and between the second plate 323b and the lower side plate of the case 321.

As the coupler 311 penetrates the case 321, one end of the coupler 311 may contact the oscillating unit (not shown), and the other end thereof may contact a portion of the first plate 323a. As the microwaves generated from the oscillating unit (not shown) are delivered to the plates 323a and 323b and the connecting portion 322 through the coupler 311, an electric field may be generated inside the assembly of the plates 323a and 323b and the connecting portion 322.

In addition, according to the structure of the resonating unit 320 of the heater assembly 300, a triple resonance mode may be formed in the resonating unit 320. Resonance of the transverse electric and magnetic (TEM) mode of microwaves is formed between the plates 323a and 323b. Additionally, the resonance of the TEM mode, which is different from the resonance formed between the plates 323a and 323b, is generated not only between the first plate 323a and the upper side plate of the case 321 but also between the second plate 323b and the lower side plate of the case 321. Because the resonating unit 320 of FIG. 6 may resonate in the TEM mode by using the plates 323a and 323b, the resonating unit 320 of FIG. 6 may be smaller in size than the resonating unit 220 of FIG. 5 that may only resonate in the transverse electric (TE) and transverse magnetic (TM) modes.

As triple resonance occurs in the resonating unit 320 of the heater assembly 300, the aerosol generating article 10 may be more effectively and uniformly heated.

The resonating unit 320 according to the embodiment may include a closed end/short end, in which a cross-section is closed to have a length of one quarter (λ/4) of the wavelength (λ) of the microwaves, and an open end, in which at least a portion of the cross-section is open.

A region at one end of the resonating unit 320, which corresponds to the region on the left side in FIG. 6, forms a closed closed end/short end due to the structure in which the connecting portion 322 and the ends of the plates 323a and 323b are connected to the case 321. A region at the other end of the resonating unit 320, which corresponds to the region on the right side in FIG. 6, forms an open end as the opening 321a of the case 321 is exposed to the outside. With the above structure of the resonating unit 320, the resonating unit 320 may function as a resonator with a length of one quarter of the wavelength of the microwaves.

According to the above-described resonance structure of the resonating unit 320, an electric field may not propagate to the outer region of the resonating unit 320. Therefore, the heater assembly 300 may prevent the electric field from leaking to the outside of the heater assembly 300 without a separate blocking member for blocking the electric field.

The aerosol generating article 10 inserted into the accommodation space 320h of the case 321 may be surrounded by the first plate 323a and the second plate 323b and thus heated using a dielectric heating method. For example, a portion including a medium of the aerosol generating article 10 inserted into the accommodation space 320h of the case 321 may be located in the space between the first plate 323a and the second plate 323b. As dielectric materials included in the aerosol generating article 10 generate heat because of the electric field formed in the space between the first plate 323a and the second plate 323b, the aerosol generating article 10 may be heated.

In addition, secondary heating on the aerosol generating article 10 may occur due to the action of the electric field resulting from the resonance modes respectively formed between the first plate 323a and the upper side plate of the case 321 and between the second plate 323b and the lower side plate of the case 321.

When the aerosol generating article 10 is inserted into the resonating unit 320 through the accommodation space 320h, a tobacco rod 11 of the aerosol generating article 10 may be located between the plates 323a and 323b.

A length L4 of the tobacco rod 11 may be greater than a length L1 of the plates 323a and 323b. Therefore, a front end 11f of the tobacco rod 11 contacting a filter rod 12 protrudes more in a direction towards the opening 321a of the case 321, compared to the other end 323af of the first plate 323a and the other end 323bf of the second plate 323b.

Resonance peaks are formed at the other ends of the plates 323a and 323b operating as the resonators, allowing for the generation of a stronger electric field at the other ends than in other regions. When the aerosol generating article 10 is inserted into the heater assembly 300, the tobacco rod 11 including the dielectric materials capable of generating heat by the electric field is arranged to correspond to the region where the electric field is the strongest, and thus the heating efficiency (or the ‘dielectric heating efficiency’) of the heater assembly 300 may be improved.

Referring to FIG. 6, the length L1 of the plates 323a and 323b may be set to be less than the length L1+L2 of the inner space of the case 321. Therefore, the other ends of the plates 323a and 323b may be arranged on the inner side of the case 321 compared to the opening 321a. In other words, the other ends of the plates 323a and 323b may be spaced apart from the rear end of the opening 321a by a length of L2.

The length from the rear end of the opening 321a, where the opening 321a is connected to the case 321, to the front end of the opening 321a, where the opening 321a is open, may be L3. The total length of the case 321 along the lengthwise direction of the case 321 may be L. The total length L of the case 321 may be determined by the sum of the length L1 of the plates 323a and 323b, the length L2 between the plates 323a and 323b and the rear end of the opening 321a, and the length L3 where the opening 321a protrudes from the case 321.

To prevent the microwave leakage, the front end of the opening 321a, where the opening 321a is open, protrudes from the case 321 by a length of L3. As the opening 321a of the case 321 protrudes from the case 321, the opening 321a may prevent the microwaves in the case 321 of the resonating unit 320 from leaking to the outside of the case 321.

The resonating unit 320 may further include a dielectric accommodation space 327 for accommodating dielectric materials. The dielectric accommodation space 327 may be formed in the empty space between the case 321 and the plates 323a and 323b. In the dielectric accommodation space 327, dielectric materials with low microwave absorption may be accommodated.

As the dielectric materials are arranged within the dielectric accommodation space, the heater assembly 300 may generate an electric field, which is similar to an electric field produced by a resonating unit with no dielectric materials, may be generated while reducing the overall size of the resonating unit 320. In other words, the mounting space for the resonating unit 320 in the aerosol generating device may decrease by reducing the size of the resonating unit 320 by using the dielectric materials arranged within the dielectric accommodation space 327, leading to the miniaturization of the aerosol generating device.

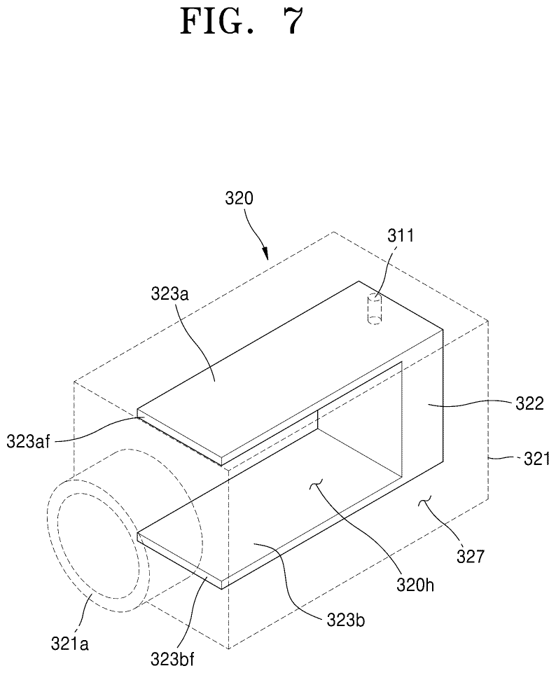

FIG. 7 is a perspective view schematically illustrating a heater assembly according to another embodiment.

The heater assembly according to the embodiment illustrated in FIG. 7 may include a resonance unit 320 that generates microwave resonance, a coupler 311 that supplies microwaves to the resonance unit 320.

A case 321 of the resonance unit 320 may include an accommodation space 320h in which an aerosol generating article may be accommodated and an opening 321a into which an aerosol generating article may be inserted.

One end of each of a plurality of plates 323a and 323b of the resonance unit 320 may be connected to a connection portion 322. The plurality of plates 323a and 323b may be connected to the case 321 by the connection portion 322. The other end of each of the plurality of plates 323a and 323b may be open toward the opening 321a of the case 321.

The case 321 of the resonance unit 320, the plurality of plates 323a and 323b, and the connection portion 322 may each include a metal material.

The plurality of plates 323a and 323b may be separated from each other in a peripheral direction of an aerosol generating article accommodated in the accommodation space 320h. The plurality of plates 323a and 323b may include a first plate 323a surrounding one region of an aerosol generating article and a second plate 323b surrounding another region of the aerosol generating article.

“A plurality of plates are separated from each other in a peripheral direction of an aerosol generating article” may mean that the plurality of plates are arranged at different positions in the peripheral direction of the aerosol generating article.

Also, “a plurality of plates are separated from each other in a peripheral direction of an aerosol generating article” may mean that the plurality of plates are arranged at different positions in the peripheral direction centered on a “longitudinal direction” in which a heater assembly or an aerosol generating device extends.

“A plurality of plates surround a part of an aerosol generating article” may mean that the plurality of plates are arranged to face an outer surface of the aerosol generating article by extending in a peripheral direction of the outer surface of the aerosol generating article. The plurality of plates may have simple flat shapes and surround a part of the outer surface of the aerosol generating article. In another example, the plurality of plates may surround a part of the outer surface of the aerosol generating article while including a bent or curved shape corresponding to a cross-sectional shape of the aerosol generating article.

The first plate 323a and the second plate 323b may be respectively arranged on an upper side and a lower side of the accommodation space 320h and may face each other. Each of the first plate 323a and the second plate 323b may include a thin, flat, and rectangular plate extending in a direction into which an aerosol generating article is inserted.

A shape of each of the plurality of plates 323a and 323b may be modified in various ways. For example, each of the plurality of plates 323a and 323b may be modified to have a shape of a square plate, a polygonal plate, a circular plate, or an oval plate.

The plurality of plates 323a and 323b may be connected to the case 321 by the connection portion 322. Also, one end of the first plate 323a among the plurality of plates 323a and 323b may be connected to one end of the second plate 323b among the plurality of plates 323a and 323b by the connection portion 322. Therefore, an end portion closed by the connection portion 322 may be formed at one end of each of the plurality of plates 323a and 323b.

The other end 323af of the first plate 323a among the plurality of plates 323a and 323b and the other end 323bf of the second plate 323b among the plurality of plates 323a and 323b may be opened by being separated from each other. Because the other ends of the plurality of plates 323a and 323b are separated from each other, open end portions may be formed at the other ends of the plurality of plates 323a and 323b.

The accommodation space 320h between the first plate 323a and the second plate 323b is open in an inner space of the case 321 by side surfaces of the first plate 323a and the second plate 323b.

An open end of the other end of each of the plurality of plates 323a and 323b may face the opening 321a of the case 321. The opening 321a of the case 321 may be separated from the other ends of the plurality of plates 323a and 323b to be away from the other ends. As the opening 321a protrudes from the case 321, it is possible to prevent microwaves inside the case 321 from leaking to the outside of the case 321.

The open end portions of the other ends of the plurality of plates 323a and 323b may be aligned with respect to the opening 321a of the case 321. Therefore, when an aerosol generating article is inserted into the accommodation space 320h through the opening 321a of the case 321, a part of the aerosol generating article in the accommodation space 320h may be surrounded by the plurality of plates 323a and 323b.

When microwaves are supplied to the resonance unit 320 by the coupler 311, microwave resonance occurs in the resonance unit 320, and accordingly, the resonance unit 320 may heat an aerosol generating article inserted between the plurality of plates 323a and 323b.

A dielectric accommodation space 327 is formed between the case 321 and each of the plurality of plates 323a and 323b. The dielectric accommodation space 327 may be empty. Also, a dielectric with low microwave absorption may be accommodated in the dielectric accommodation space 327.

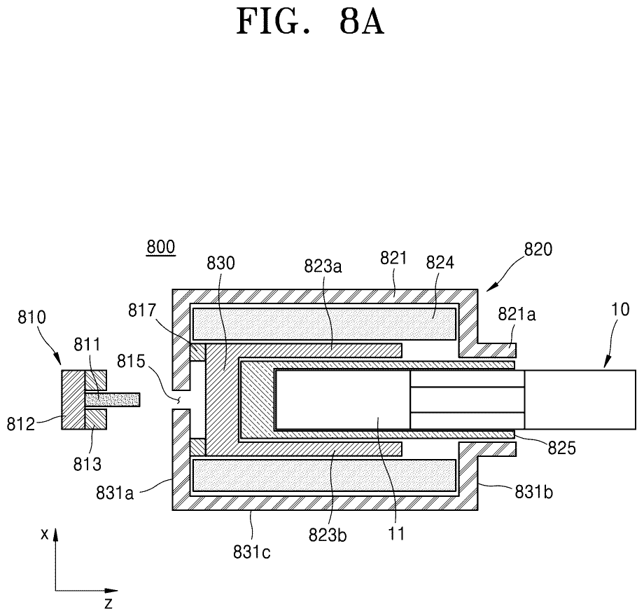

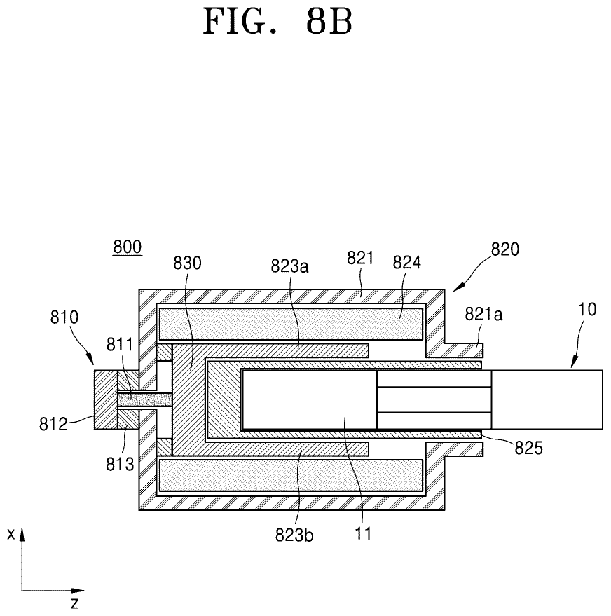

FIG. 8A is a cross-sectional view of a heater assembly according to an embodiment. FIG. 8B is a cross-sectional view of the heater assembly of FIG. 8A in which a resonance unit is coupled to an oscillator.

Referring to FIG. 8A, a heater assembly 800 according to an embodiment may include an oscillation module 810 and a resonance unit 820. In this case, the oscillation module 810 may include a coupler 811, an oscillator 812, and a bracket 813.

The resonance unit 820 may include a case 821, a plurality of plates 823a and 823b, and a connection portion 830 connecting the plurality of plates 823a and 823b to each other.

The coupler 811 may supply microwaves to at least one of the plurality of plates 823a and 823b to cause the resonance unit 820 to generate microwave resonance.

The resonance unit 820 may surround at least a part of an aerosol generating article 10 inserted into an aerosol generating device. Also, the coupler 811 may supply microwaves generated by the oscillator 812 to the resonance unit 820. When microwaves are supplied to the resonance unit 820, microwave resonance occurs in the resonance unit 820, and the resonance unit 820 may heat the aerosol generating article 10. For example, dielectrics included in the aerosol generating article 10 may be heated by an electric field generated inside the resonance unit 820 by the microwaves, and the aerosol generating article 10 may be heated by the heat generated by the dielectric.

When the aerosol generating article 10 is inserted into a support tube 825 of the resonance unit 820, a tobacco rod 11 of the aerosol generating article 10 may be placed between the plurality of plates 823a and 823b. Because one closed surface of the support tube 825 supports a left end portion of the tobacco rod 11, movement of the aerosol generating article 10 toward the left may be restricted.

A front end portion of the tobacco rod 11 in contact with the filter rod 11 may be at a position protruding more than the other end of the first plate 823a and the other end of the second plate 823b in a direction toward the opening 821a of the case 821.

Lengths of the plurality of plates 823a and 823b may be set to be less than a length of the inner space of the case 821. Therefore, the other ends of the plurality of plates 823a and 823b may be at a position separated further inward from the opening 821a of the case 821.

A front end portion of a dielectric 824 inside the resonance unit 820 may protrude more than the other ends of the plurality of plates 823a and 823b in a longitudinal direction of the case 821. In FIGS. 8A and 8B, the front end of the dielectric 824 may be in contact with an inner surface of the case 821. A length, by which the front end portion of the dielectric 824 protrudes more than the other ends of the plurality of plates 823a and 823b, may be changed. Therefore, although the front end portion of the dielectric 824 protrudes more than the other ends of the plurality of plates 823a and 823b, the front end portion of the dielectric 824 may be separated from the inner surface (for example, an upper surface 831b) of the case 821 so as not to be in contact with the inner surface of the case 821.

The case 821 may include a lower surface 831a, the upper surface 831b facing the lower surface 831a, and a side surface 831c surrounding a space between the lower surface 831a and the upper surface 831b. At least some (for example, the plurality of plates 823a and 823b and the support tube 825) of components of the resonance unit 820 may be arranged in an inner space of the resonance unit 820 which is formed by the lower surface 831a, the upper surface 831b, and the side surface 831c.

In one embodiment, the resonance unit 820 may further include a fixing member 817 for fixing the plurality of plates 823a and 823b to the case 821. For example, the fixing member 817 may be between one region of a lower surface (for example, one region toward the −z direction) of the connection portion 830 and one region of the upper surface (for example, one region toward the z direction) of the lower surface 831a of the case 821.

In one embodiment, the case 821 may include at least one opening 815 into which the coupler 811 may be inserted. For example, when the coupler 811 is composed of a single elongated connector, the case 821 may include one opening 815 into which a single elongated connector may be inserted.

In one embodiment, the case 821 may include the opening 815 in the lower surface 831a such that the coupler 811 may be inserted into the opening 815 from the outside in the z direction. For example, as the opening 815 is formed in the center of the lower surface 831a of the case 821, the coupler 811 may be connected to the connection portion 830 by passing through the lower surface 831a through the opening 815.

In the present disclosure, as the coupler 811 may be inserted through the opening 815 formed in a lower surface of the resonance unit 820, the possibility of a design change for the heater assembly 800 and an aerosol generating device (for example, the aerosol generating device 100 of FIG. 1) into which the heater assembly 800 is inserted increases, and thus, the aerosol generating device may be reduced in size, and aesthetics of the aerosol generating device may be improved. That is, when a resonance unit is on a lower surface of a heater assembly compared to that the resonance unit is on a side surface of the heater assembly, another component may be on a portion that is adjacent to a side surface of the resonance unit, and thus, an aerosol generating device may be reduced in size.

Also, the present disclosure has no obstacle that interferes with the emission of microwaves between the case 821 and the plurality of plates 823a and 823b of the resonance unit 820, and thus, the efficiency of microwave resonance may be increased.

That is, as the coupler 811 for transmitting microwaves to the resonance unit 820 is arranged on a lower surface of the resonance unit 820, the fixing member 817 is between the case 821 and the plurality of plates 823a and 823b, but the fixing member 817 is an insulator that does not interfere with the emission of microwaves, and thus, the heater assembly 800 of the present disclosure may increase the efficiency of microwave resonance.

In one embodiment, a shape, number, and size of the coupler 811 may correspond to a shape, number, and size of the opening 815 included in the case 821. For example, when the coupler 811 has a cylindrical shape, the opening 815 may have a circular shape such that the cylindrical coupler 811 may be inserted into the opening 815. In another example, a diameter of the coupler 811 may be formed to be substantially less than a diameter of the opening 815.

Referring to FIG. 8B, the coupler 811 is inserted through the opening 815 of the case 821, the coupler 811 may connect the oscillator 812 to the connection portion 830. The oscillator 812 may generate microwaves in a designated frequency band as an alternating current (AC) voltage is applied. Accordingly, as the oscillator 812 is connected to the connection portion 830 by the coupler 811, microwaves generated by the oscillator 812 may be transmitted to the coupler 811 and the connection portion 830 and transmitted to the plurality of plates 823a and 823b.

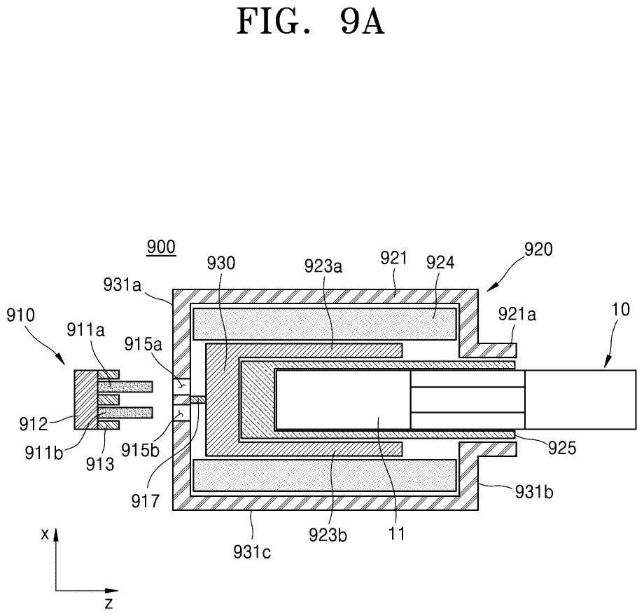

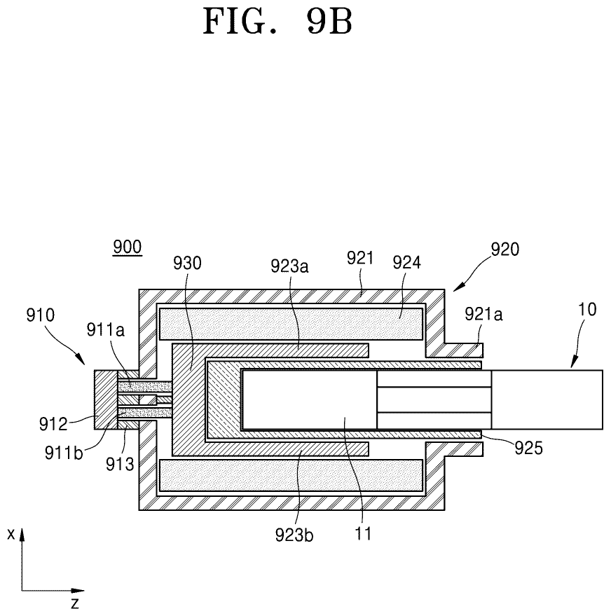

FIG. 9A is a cross-sectional view of a heater assembly according to another embodiment. FIG. 9B is a cross-sectional view of the heater assembly of FIG. 9A in which a resonance unit is coupled to an oscillator.

Referring to FIG. 9A, a heater assembly 900 according to the embodiment may include an oscillation module 910 and a resonance unit 920. In this case, the oscillation module 910 may include couplers 911a and 911b, an oscillator 912, and a bracket 913.

The resonance unit 920 may include a case 921, the plurality of plates 923a and 923b, and the connection portion 930 connecting the plurality of plates 923a and 923b to each other.

The couplers 911a and 911b may supply microwaves to at least one of the plurality of plates 923a and 923b to generate microwave resonance in the resonance unit 920.

The resonance unit 920 may surround at least one region of an aerosol generating article 10 inserted into an aerosol generating device. Also, the couplers 911a and 911b may provide microwaves generated by the oscillator 912 to the resonance unit 920. When microwaves are provided to the resonance unit 920, microwave resonance occurs in the resonance unit 920, and accordingly, the resonance unit 920 may heat the aerosol generating article 10. For example, dielectrics included in the aerosol generating article 10 may be heated by an electric field generated inside the resonance unit 920 by the microwave, and the aerosol generating article 10 may be heated by the heat generated by the dielectrics.

When the aerosol generating article 10 is inserted into a support tube 925 of the resonance unit 920, a tobacco rod 11 of the aerosol generating article 10 may be placed between the plurality of plates 923a and 923b. Because a closed surface of one end of the support tube 925 supports a left end portion of the tobacco rod 11, movement of the aerosol generating article 10 toward the left may be restricted.

A front end of the tobacco rod 11 in contact with a filter rod may be at a position that protrudes more than the other end of the first plate 923a and the other end of the second plate 923b in a direction toward the opening 921a of the case 921.

Lengths of the plurality of plates 923a and 923b may be set to be less than a length of the inner space of the case 921. Therefore, the other ends of the plurality of plates 923a and 923b may be at a position separated from the inside of the case 921 more than the opening 921a.

A front end portion of a dielectric 924, which is arranged inside the resonance unit 920, may protrude more than the other ends of the plurality of plates 923a and 923b in a longitudinal direction of the case 921. In FIGS. 9A and 9B, a front end portion of the dielectric 924 may be in contact with an inner surface of the case 921. A length by which the front end portion of the dielectric 924 protrudes more than the other ends of the plurality of plates 923a and 923b may be modified in various ways. Therefore, although the front end portion of the dielectric 924 protrudes more than the other ends of the plurality of plates 923a and 923b, the front end portion of the dielectric 924 may be separated from an inner surface (for example, an upper surface 931b) of the case 921 so as not to be in contact with the inner surface of the case 921.

The case 921 may include a lower surface 931a, the upper surface 931b facing the lower surface 931a, and a side surface 931c surrounding a space between the lower surface 931a and the upper surface 931b. At least some (for example, the plurality of plates 923a and 923b and a support tube 925) of components of the resonance unit 920 may in an inner space of the resonance unit 920 formed by the lower surface 931a, the upper surface 931b, and the side surface 931c.

In one embodiment, the resonance unit 920 may further include a fixing member 917 for fixing the plurality of plates 923a and 923b to the case 921. For example, the fixing member 917 may be between one region of a lower surface (for example, a surface toward the −z direction) of the connection portion 930 and one region of an upper surface (for example, one surface toward the z direction) of the lower surface 931a of the case 921.

In one embodiment, the case 921 may include a plurality of openings 915a and 915b into which the coupler 911a and 911b may be inserted. For example, when the couplers 911a and 911b are configured by two elongated connectors (that is, a receptacle plug structure), the case 921 may include two openings 915a and 915b through which the two elongated connectors may be inserted.

In one embodiment, the case 921 may include a plurality of openings 915a and 915b in the lower surface 931a through which the couplers 911a and 911b may be inserted from the outside in the z direction. For example, as the openings 915a and 915b are formed in the center of the lower surface 931a of the case 921, the couplers 911a and 911b may be connected to the connection portion 930 by passing through the lower surface 931a through the openings 915a and 915b.

In the present disclosure, as the couplers 911a and 911b may be inserted through the openings 915a and 915b formed in a lower surface of the resonance unit 920, the possibility of a design change for the heater assembly 900 and an aerosol generating device (for example, the aerosol generating device 100 of FIG. 1) into which the heater assembly 800 is inserted increases, and thus, the aerosol generating device may be reduced in size, and aesthetics of the aerosol generating device may be improved. That is, when a resonance unit is on a lower surface of a heater assembly compared to the resonance unit is on a side surface of the heater assembly, another component may be on a portion that is adjacent to a side surface of the resonance unit, and thus, an aerosol generating device may be reduced in size.

Also, the present disclosure has no obstacle that interferes with the emission of microwaves between the case 921 and the plurality of plates 923a and 923b of the resonance unit 920, and thus, the efficiency of microwave resonance may be increased. That is, as the couplers 911a and 911b for transmitting microwaves to the resonance unit 920 is arranged on a lower surface of the resonance unit 920, the fixing member 917 is between the case 921 and the plurality of plates 923a and 923b, but the fixing member 917 is an insulator that does not interfere with the emission of microwaves, and thus, the heater assembly 900 of the present disclosure may increase the efficiency of microwave resonance.

In one embodiment, shapes, numbers, and sizes of the couplers 911a and 911b may correspond to shapes, numbers, and sizes of the openings 915a and 915b included in the case 921. For example, when the couplers 911a and 911b have a cylinder shape and are two in number, the openings 915a and 915b may have a cylinder shape and two circular shapes such that two couplers 911a and 911b may be inserted. In another example, diameters of the couplers 911a and 911b may be formed to be substantially less than diameters of the openings 915a and 915b.

Referring to FIG. 9B, the couplers 911a and 911b are inserted through the openings 915a and 915b of the case 921, and accordingly, the couplers 911a and 911b may connect the oscillator 912 to the connection portion 930. The oscillator 912 may generate microwaves in a designated frequency band as an AC voltage is applied. Accordingly, as the oscillator 912 is connected to the connection portion 930 by the couplers 911a and 911b, microwaves generated by the oscillator 912 may be transmitted to the couplers 911a and 911b and the connection portion 930 and transmitted to the plurality of plates 923a and 923b.

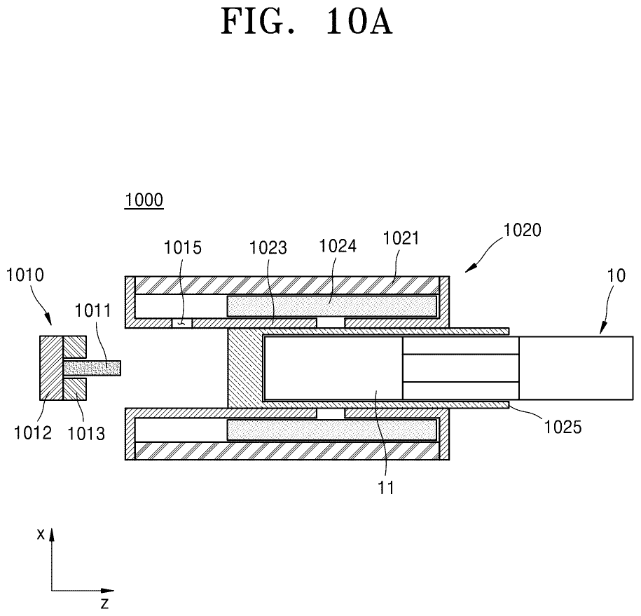

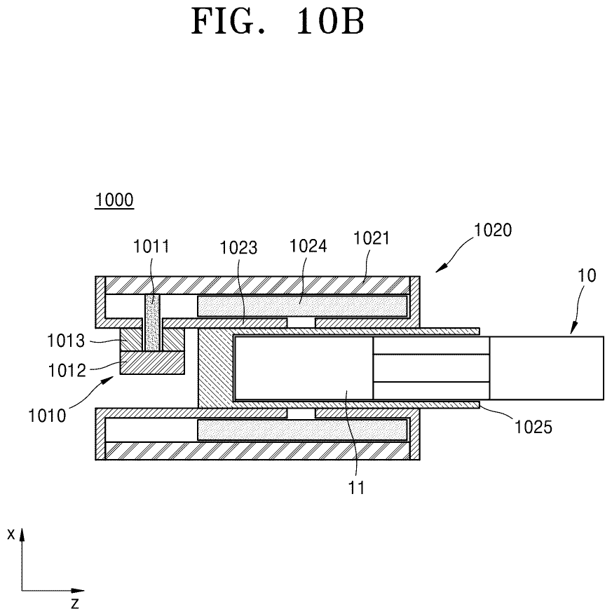

FIG. 10A is a cross-sectional view of a heater assembly according to another embodiment. FIG. 10B is a cross-sectional view of the heater assembly of FIG. 10A in which a resonance unit is coupled to an oscillator.

Referring to FIG. 10A, a heater assembly 1000 according to the embodiment may include an oscillation module 1010 and a resonance unit 1020. In this case, the oscillation module 1010 may include a coupler 1011, an oscillator 1012, and a bracket 1013.

The resonance unit 1020 may include an outer conductor 1021 and an inner conductor 1023. In this case, the inner conductor 1023 may include a first inner conductor (for example, the first inner conductor 223 of FIG. 5) and a second inner conductor (for example, the second inner conductor 225 of FIG. 5).

When the aerosol generating article 10 is inserted into the support tube 1025 of the resonance unit 1020, a tobacco rod 11 of an aerosol generating article 10 may be inside the inner conductor 1023. Because a closed surface of one end of the support tube 1025 supports a left end portion of the tobacco rod 11, movement of the aerosol generating article 10 toward the left may be restricted.

In FIG. 10A and FIG. 10B, a front end portion of a dielectric 1024 arranged inside the resonance unit 1020 may be in contact with an inner surface of the inner conductor 1023. However, the present disclosure is not limited thereto, and the front end portion of the dielectric 1024 may be separated from the inner surface of the inner conductor 1023 such that the front end portion of the dielectric 1024 is not in contact with the inner surface of the inner conductor 1023.

The outer conductor 1021 may form the entire appearance of the resonance unit 1020 and may have the inside formed in a hollow shape, and accordingly, components of the resonance unit 1020 may be arranged inside the outer conductor 1021. The outer conductor 1021 may include an accommodation space in which the aerosol generating article 10 may be accommodated, and the aerosol generating article 10 may be inserted into the outer conductor 1021 through an accommodation space.

In one embodiment, the outer conductor 1021 may include a lower surface (for example, the first surface 221a of FIG. 5), an upper surface (for example, the second surface 221b of FIG. 5) facing the lower surface, and a side surface (for example, the side surface 221c of FIG. 5) surrounding a free space between the lower surface and the upper surface. At least some (for example, the inner conductor 1023) of components of the resonance unit 1020 may be in an inner space of the resonance unit 1020 which is formed by the lower surface, the upper surface, and the side surface.

In one embodiment, the first inner conductor 223 of the inner conductor 1023 may include at least one opening 1015 into which the coupler 1011 may be inserted. For example, when the coupler 1011 is composed of one elongated connector, the first inner conductor 223 of the inner conductor 1023 may include the one opening 1015 into which the one elongated connector may be inserted.

In one embodiment, the first inner conductor 223 of the inner conductor 1023 may include the opening 1015 formed in a surface toward the inner space of the resonance unit 1020 such that the coupler 1011 may be inserted from the outside in the x direction. For example, as the opening 1015 is formed in one region of the first inner conductor 223 of the inner conductor 1023 which faces the inner space, the coupler 1011 may be connected to the outer conductor 1021 by passing through the one region through the opening 1015.

In the present disclosure, as the coupler 1011 is inserted from the inner space of the resonance unit 1020 through the opening 1015, the possibility of a design change for the heater assembly 1000 and an aerosol generating device (for example, the aerosol generating device 100 of FIG. 1) into which the heater assembly 1000 is inserted increases, and thus, the aerosol generating device may be reduced in size, and aesthetics of the aerosol generating device may be improved. That is, when a resonance unit is on an outer side surface of a heater assembly compared to that the resonance unit is on an inner side surface of the heater assembly, another component may be on a portion that is adjacent to the outer side surface of the resonance unit, and thus, an aerosol generating device may be reduced in size.

In addition, the present disclosure has no obstacle that interferes with the emission of microwaves between the outer conductor 1021 and the inner conductor 1023 of the resonance unit 1020, and thus, the efficiency of microwave resonance may be increased.

In one embodiment, a shape, number, and size of the coupler 1011 may correspond to a shape, number, and size of the opening 1015 included in the inner conductor 1023. For example, when the coupler 1011 has a cylindrical shape, the opening 1015 may have a circular shape such that a cylindrical coupler 1011 may be inserted. Also, a diameter of the coupler 1011 may be formed to be substantially less than a diameter of the opening 1015.

Referring to FIG. 10B, as the coupler 1011 is inserted through the opening 1015 of the inner conductor 1023 (for example, the first inner conductor), the coupler 1011 may connect the oscillator 1012 to the outer conductor 1021. However, this is an example, and in other embodiments, the coupler 1011 may connect the oscillator 1012 to the inner conductor 1023. The oscillator 1012 may generate microwaves in a designated frequency band as an AC voltage is applied. Accordingly, as the oscillator 1012 is connected to the outer conductor 1021 through the coupler 1011 or the oscillator 1012 is connected to the inner conductor 1023 through the coupler 1011, a region formed by the outer conductor 1021 and the first inner conductor 223 and a region formed by the outer conductor 1021 and the second inner conductor 225 may operate as a resonator having a quarter of a wavelength of the microwave generated by the oscillator 1012.

Any embodiments of the present disclosure or other embodiments described above are not mutually exclusive or distinct from each other. Any embodiment or other embodiments described in this disclosure may be combined with one another, both in terms of configurations and functions.

For example, configuration A from a specific embodiment and/or drawing can be combined with configuration B from another embodiment and/or drawing. This means that even if a combination of components is not explicitly described, such combinations are still possible unless specifically stated otherwise.

The detailed description above should not be interpreted as limiting in any respect, but rather as illustrative. The scope of the present disclosure should be defined by a reasonable interpretation of the appended claims, and all modifications that fall within the equivalent scope of the present disclosure are included in its scope.

1. A heater assembly comprising:
an oscillator configured to generate microwaves in a designated frequency band; and
a resonance unit configured to receive the microwaves generated by the oscillator through a coupler and generate an electric field by resonating the received microwaves,
wherein the resonance unit includes:
a case including a lower surface, an upper surface facing the lower surface, a side surface surrounding an inner space between the lower surface and the upper surface, an accommodation space for accommodating an aerosol generating article, and at least one opening into which the coupler is insertable in a direction from the lower surface toward the inner space;
a plurality of plates separated from each other in a peripheral direction of the aerosol generating article accommodated in the accommodation space; and
a connection portion connecting the plurality of plates to each other.

2. The heater assembly of claim 1, wherein the coupler connects the oscillator to the connection portion and is configured to transmit the microwaves generated by the oscillator to the plurality of plates.

3. The heater assembly of claim 1, wherein first ends of the plurality of plates are connected to the connection portion, and second ends of the plurality of plates are separated from each other and are open.

4. The heater assembly of claim 1, wherein one end of the coupler is connected to the oscillator, and another end of the coupler passes through the at least one opening of the case to be connected to the connection portion.

5. The heater assembly of claim 1, wherein the resonance unit further includes a fixing member configured to fix the plurality of plates to the case.

6. The heater assembly of claim 1, wherein a shape and a number of the coupler corresponds to a shape and a number, respectively, of the at least one opening included in the case.

7. The heater assembly of claim 1, wherein the resonance unit further includes:
a dielectric accommodation space formed between the case and the plurality of plates; and
a dielectric arranged in the dielectric accommodation space.

8. The heater assembly of claim 7, wherein the dielectric is separated from the upper surface of the case by a preset distance in a direction toward the inner space.

9. A heater assembly comprising:
an oscillator configured to generate microwaves in a designated frequency band; and
a resonance unit configured to receive the microwaves generated by the oscillator through a coupler and generate an electric field by resonating the received microwaves,
wherein the resonance unit includes:
an outer conductor including a lower surface, an upper surface facing the lower surface, and a side surface surrounding an inner space between the lower surface and the upper surface, and including an accommodation space for accommodating an aerosol generating article;
a first inner conductor surrounding one region of the aerosol generating article accommodated in the accommodation space and including at least one opening into which the coupler is able to be inserted; and
a second inner conductor surrounding another region of the aerosol generating article accommodated in the accommodation space.

10. The heater assembly of claim 9, wherein
the coupler connects the oscillator to the first inner conductor, and
a region formed by the outer conductor and the first inner conductor and another region formed by the outer conductor and the second inner conductor operate as a resonator having a quarter of a wavelength of each of the microwaves generated by the oscillator.

11. The heater assembly of claim 9, wherein
the first inner conductor and the second inner conductor are each formed in a hollow cylindrical shape surrounding one region of the aerosol generating article accommodated in the accommodation space, and
the resonance unit further includes a closing portion that is inside the first inner conductor and closes a cross-section of the first inner conductor.

12. The heater assembly of claim 9, wherein one end of the coupler is connected to the oscillator, and another end of the coupler passes through the at least one opening of the first inner conductor to be connected to the outer conductor.

13. The heater assembly of claim 9, wherein the resonance unit includes:
a dielectric accommodation space formed between the outer conductor, the first inner conductor, and the second inner conductor; and
a dielectric arranged in the dielectric accommodation space.

14. The heater assembly of claim 13, wherein the dielectric is separated from an upper surface of the outer conductor by a preset distance in a direction toward the inner space.

15. An aerosol generating device comprising:
a housing including an insertion hole into which an aerosol generating article is inserted; and
a heater assembly configured to heat the aerosol generating article inserted through the insertion hole,
wherein the heater assembly includes:
an oscillator configured to generate microwaves in a designated frequency band; and
a resonance unit configured to receive the microwaves generated by the oscillator through a coupler and generate an electric field by resonating the received microwaves, and
the resonance unit includes:
a case including a lower surface, an upper surface facing the lower surface, a side surface surrounding an inner space between the lower surface and the upper surface, an accommodation space for accommodating the aerosol generating article, and at least one opening into which the coupler is insertable in a direction from the lower surface toward the inner space;
a plurality of plates separated from each other in a peripheral direction of the aerosol generating article accommodated in the accommodation space; and
a connection portion connecting the plurality of plates to each other.
